(19) United States
(12) Patent Application Publication
(10) Pub. No.: US 2011/0114213 A1
(43) Pub. Date: May 19, 2011

(54) WATER POWERED HYDRAULIC SWAGE SYSTEM AND METHOD FOR WELL CASING REPAIR

(76) Inventor: SERGIO A. LEON ZAMUDIO, HERMOSILLO (MX)

(21) Appl. No.: 12/622,280

(22) Filed: Nov. 19, 2009

(51) Int. Cl. F16L 55/18

(52) U.S. Cl. 138/97

(57) ABSTRACT

A system for well casing pipe repair has a hydraulic circular press (1). Double piping (2) is coupled to the hydraulic circular press (1). A directional valve (3) is coupled to the double piping (2). A power unit (4) is coupled to the directional valve (3). A fluid reservoir (5) is coupled to the power unit (4).

### FIELD OF THE INVENTION

This invention relates generally to well casing repair, and more particularly, to a water power hydraulic swage system and method for repairing well casings.

### BACKGROUND OF THE INVENTION

Deep wells that are dug for a water supply generally have are lined with metal casings. These metal casings may become bent or damaged when the earth around them shifts. When this happens, the supply of water is interrupted and the urgent need to repair them is created.

There is a tool known as Electra hydraulic Swage Press that is used to repair casing breakages. In operation, the swage press is introduced into the well. The swage press carries an electric motor inside of its body. The motor moves a hydraulic pump which moves expandable metal-forming surfaces into the well where the damaged portion is located to expand outward to bend the damaged portion to its original position. Often a liner is then lowered to the damaged portion and the swage operated again to press the liner into position over the damaged portion as a patch.

Swages commonly used for well casing repair require an above-ground power source and a power line running to an electric motor located in the swage. Typically, the motor drives a hydraulic pump, also located within the swage, which uses hydraulic pressure to operate the metal-forming surfaces. As the power line increases in length (i.e., the deeper the well), so does the voltage drop. Voltage drop is the reduction in voltage between the source and load. The greater the voltage drop the less efficient the distribution of power and hence the operation of the motor which drives the hydraulic pump.

Furthermore, the hydraulic pump generally produces pressure of about 10,000 psi to operate the swage. The generation of such pressure will generates high temperatures during operation, and thus requires frequent interruptions to allow the pump to cool down and continue operating. High temperatures also allow filtration of hydraulic liquid and malfunctioning.

In general, the prior art swage needs from 45 to 60 seconds to complete one cycle, which comprehends the conversion of electrical energy into mechanical force, the full opening of its jaws, and the development of its thrust force.

Therefore, a need existed to provide a system and method to overcome the above problems. The system and method would require less pressure to operate the swage. The system and method would also reduce the duration of the hydraulic cycles thereby making it faster than the Electro hydraulic Swage press of the prior art.

### SUMMARY OF THE INVENTION

A system for well casing pipe repair has a hydraulic circular press. Double piping is coupled to the hydraulic circular press. A directional valve is coupled to the double piping. A power unit is coupled to the directional valve. A fluid reservoir is coupled to the power unit.

A system for well casing pipe repair has a hydraulic circular press. A plurality of double piping segments is provided wherein each of the double piping segments comprises an outer pipe and an inner pipe. The outer pipe and the inner pipe of each segment are in a concentric array. A directional valve is coupled to a first of the plurality of double piping segments. A power unit is coupled to the directional valve. A fluid reservoir is coupled to the power unit. The hydraulic circular press has a main feeder coupled to the double piping and a main body of the press.

The present invention is best understood by reference to the following detailed description when read in conjunction with the accompanying drawings.

### BRIEF DESCRIPTION OF THE DRAWINGS

FIG. 1 is a partial cross-sectional block diagram of a water powered hydraulic press system in accordance with one embodiment of the present invention;

FIG. 2 shows a cross-sectional view of segments of double piping used in the system of FIG. 1 to hold, lower, and maneuver the press inside a well;

FIG. 3 is a cross-sectional view of a hydraulic circular press shield used in the system depicted in FIG. 1; and

FIG. 4 is a magnified cross-sectional view of the body of the press used in the system of FIG. 1.

Common reference numerals are used throughout the drawings and detailed description to indicate like elements.

### DETAILED DESCRIPTION

A water powered hydraulic press system (hereinafter system) is disclosed for the repair of breakages, perforations and deformations of casing pipe of deep wells, previously found with a TV camera for deep well inspections. The system may be fully hydraulic, using short hydraulic cycles. The duration of the hydraulic cycles of the press may be from 10 to 15 seconds, which makes it faster than the electro hydraulic swage press of the prior art. The system may have operating pressure ranges from 1,500 psi to 1,800 psi, instead of the 10,000 psi generated by the electro hydraulic swage press of the prior art. The system may use a double steel pipe with a concentric array, which refers to the use of two pipes with different diameters, laying one inside of another, coupling and building them as they are being lowered into the well, until the place of the damage is reached. The double-pipe column with concentric array is used for two purposes: (1) to support the press, lower it, and make the necessary maneuvers inside of the well during the repair of the well's casing; and (2) to drive the pressurized water from the surface to the hydraulic press, allowing its operation, and after the opening and closing of its blades, return the pressurized water to the surface, completing the short-duration hydraulic cycles.

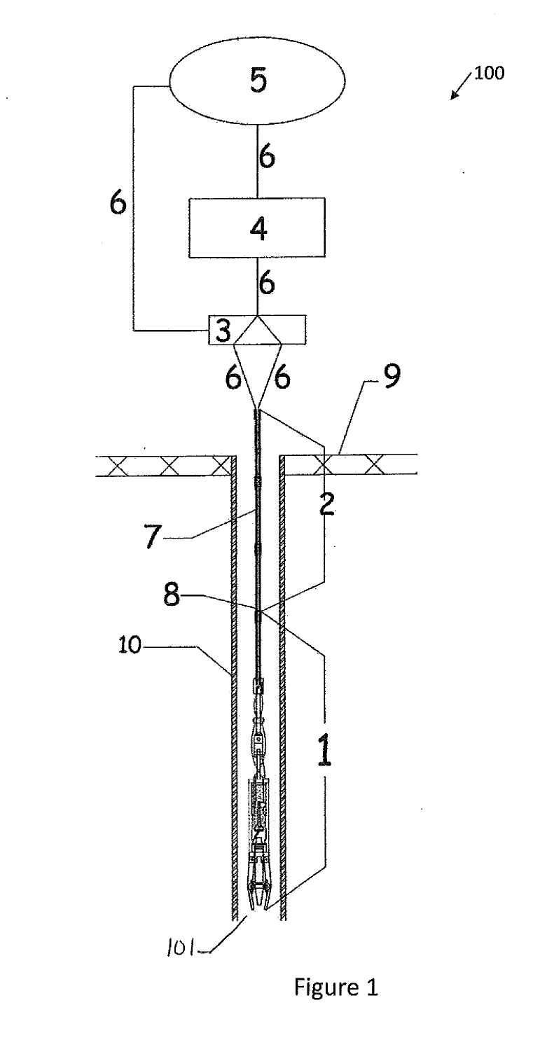

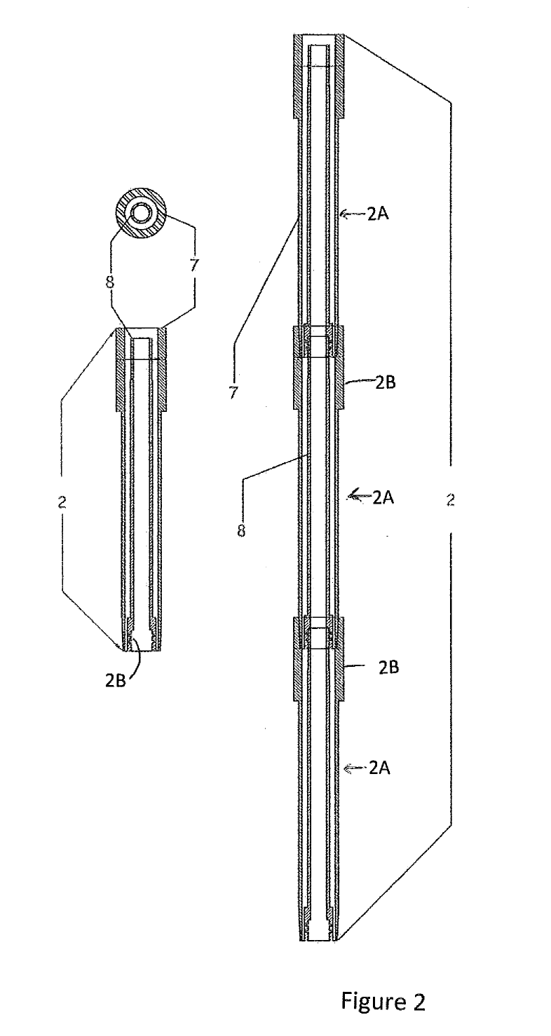

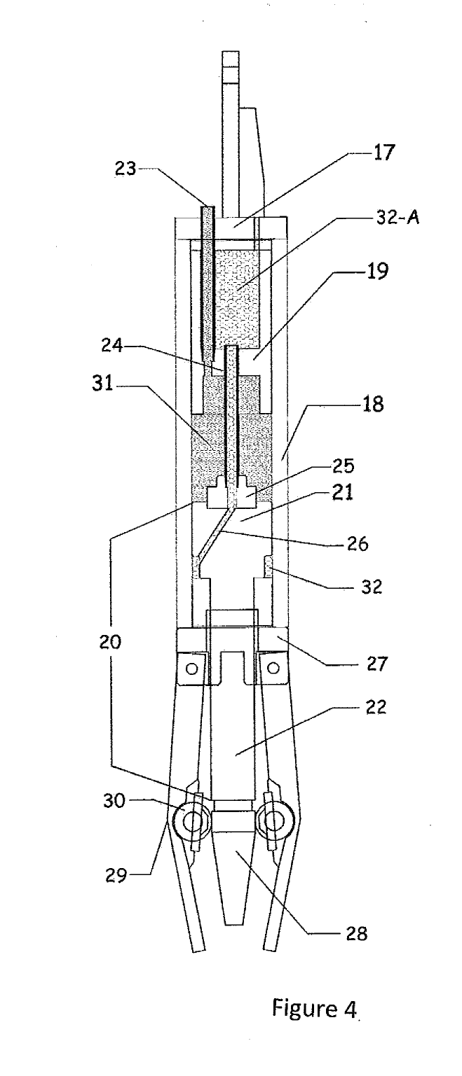

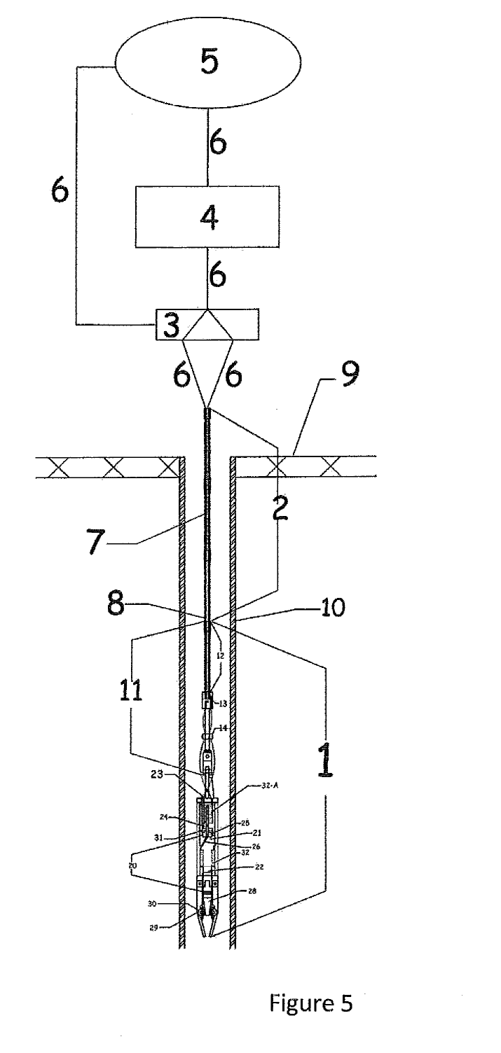

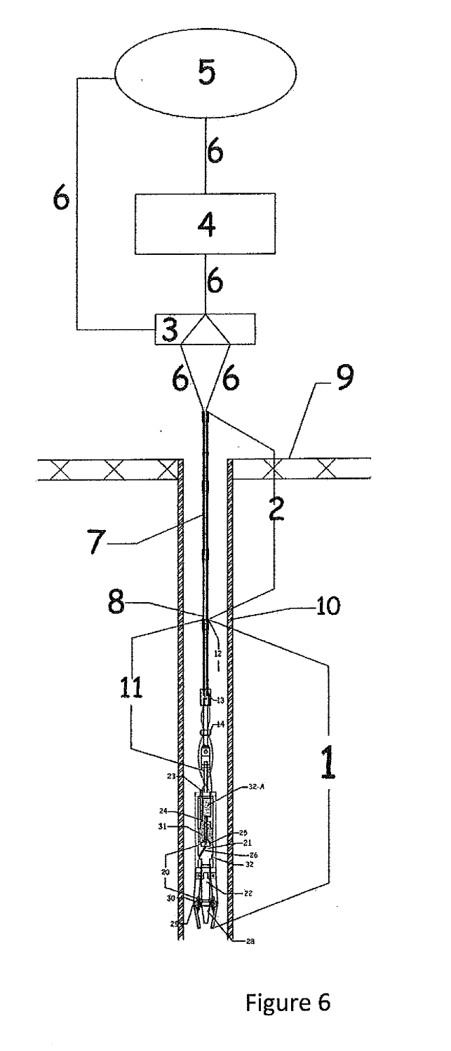

Referring now to FIG. 1, the system 100 of the present invention is shown. The system 100 may be used to repair casing pipe 10 in a well 101, located below a terrain's surface 9. The system 100 may have a hydraulic circular press 1 (hereinafter press 1). The press 1 is operated with clean pressurized water as will be disclosed below. The pressurized water is used to force open jaws 29 (FIG. 4) of the press 1. This may generate a lateral force of mechanical thrust with enough energy to reshape the casing pipe 10 inside deep well 101.

The press 1 may be coupled to double piping 2. The double piping 2 is used to hold, lower, and maneuver the press 1 inside the casing pipe 10 in the well 101 as well as to drive the pressurized water for opening and closing the jaws 29. Details of the double piping 2 will be discussed below.

The double piping 2 may further be coupled to an outlet of a directional valve 3. The directional valve 3 may be used to lead a pressurized fluid towards one of the external or internal pipes of the double piping 2. In general, hose/connectors 6 may be used to secure the double piping 2 to the outlet of the directional valve 3.

A power unit 4 may be coupled to an input of the directional valve 3. The power unit 4 may be used as a medium to pressurize a hydraulic fluid used to force open jaws 29 of the press 1. In accordance with one embodiment, the system 100 may use clean water as the hydraulic fluid. The clean water may be supplied by different sources. In the embodiment shown in FIG. 1, the clean water is stored in a water tank 5. A plurality of connector/hoses 6 may be used to couple the above components in order to establish the system 100.

In accordance to FIG. 1, the water tank 5, the power unit 4, and the directional valve 3 are generally located over the terrain's surface 9. The double piping 2 and the hydraulic press 1 are generally located inside the casing pipe 10 in the well 101, below the terrain's surface 9.

Referring now to FIG. 2, a magnified view of the double piping 2 is shown. The double piping 2 may be comprised of a plurality of segments 2A. A segment 2A of double piping 2 may be coupled to an adjacent segment 2A of double piping 2 by a pipe joint 2B. The pipe joint 2B may be any type of device for attaching adjacent segments together. In accordance with one embodiment, a threaded pipe joint may be used. The threaded pipe joint may engage threads located on outer end surfaces of each segment 2A of double piping 2.

The double piping 2 may be built in a concentric array and may be made up of an external pipe 7 and an inner pipe 8. The pressurized water may be directed to the external pipe 7 and or the internal pipe 8 as needed according to the action of opening or closing of the jaws 29. In accordance with one embodiment, each segment 2A of the double piping 2 may have an external pipe 7 and an inner pipe 8. The external pipe 7 and the inner pipe 8 of a segment 2A may be coupled to an external pipe 7 and to an inner pipe 8 respectively of an adjacent segment 2A by pipe joints 2B.

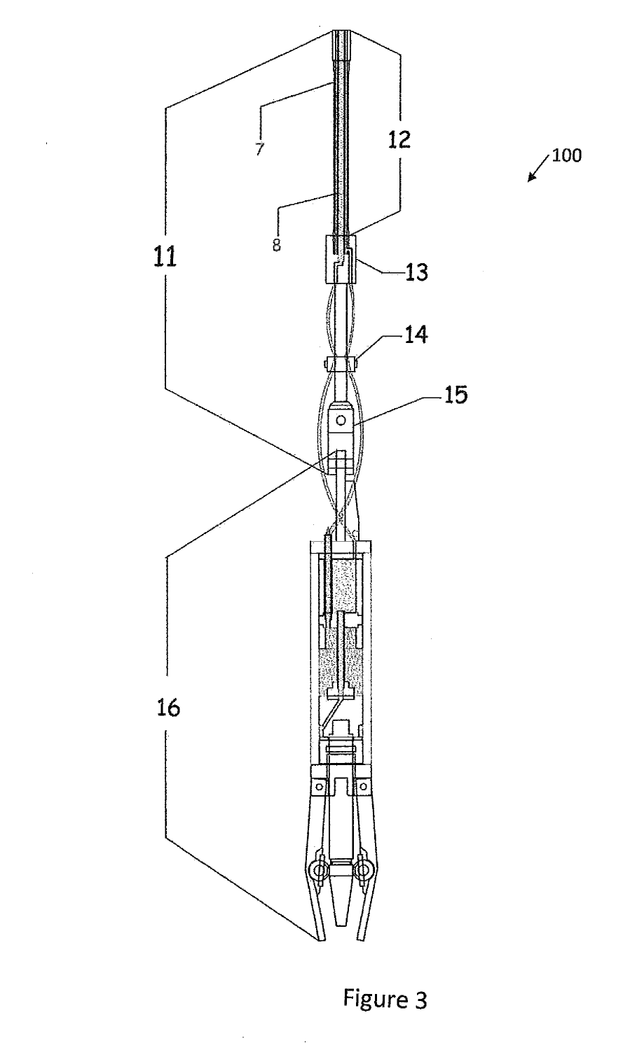

Referring now to FIG. 3, the hydraulic press 1 is shown in more detail. The hydraulic press 1 generally comprises two main parts: a main feeder 11 and a main body of the press 16. In accordance with one embodiment, the main feeder 11 may be comprised of a bottom segment 2A′ of double pipe 2. The bottom segment 2A′ of the double piping 2 may be used to couple the other segments 2A of double piping 2 to the hydraulic circular press 1.

A distributor 13 may be coupled to a bottom end of the bottom segment 2A′ of the double piping 2. The distributor 13 may be used to divide the pressurized water coming from the external pipe 7 and the internal pipe 8 and to direct the pressurized water as needed according to the action of opening or closing of the jaws 29. A double pilot check valve 14 may be coupled to the distributor 13. The double pilot check valve 14 may be used to regulate the pressure inside of the main body of the press 16 and avoid the opening and closing of the jaw 29.

The main feeder 11 may further have a universal joint 15. The universal joint 15 may be used to couple the main feeder 11 with the main body of the press 16. The universal joint 15 is a joint in a rigid structure that allows the structure to ‘bend’ in any direction. Thus, the universal joint 15 may allow main body of the press 16 to ‘bend’ in relation to the main feeder 11.

Referring to FIG. 4, the details of the components of the main body of the press 16 are shown. The main body of the press 16 has a hollow interior. An upper cover 17 and a lower cover 27 may be used to close the ends of the main body of the press 16. The upper cover 17 further may be used to couple the press 16 to the universal joint 15. The main body of the press 16 comprises and external cylinder 18 and an interior cylinder 19 located inside the top of the exterior cylinder. The interior cylinder 19 may be used to divide the flow of a hydraulic piston 20 push and return.

The hydraulic piston 20 may be composed of a piston head 21 and piston rod 22. A pushing pipe 23 may be used to join the flow originating from the exterior pipe 7 with the upper end of the hydraulic piston 20. The pushing pipe 23 goes through the upper cover 17 and the interior cylinder 19 allowing the pressurized water to get to an upper cavity 31 of the hydraulic piston 20. A return pipe 24 may be used to join the flow originating from the interior pipe 8 with the lower cavity 32 of the hydraulic piston 20. The return pipe 24 may be coupled to the upper part of the hydraulic piston 20 by a packing gland 25. The return pipe 24 allows the flow of pressurized water through the orifice 26 on the piston head 21, to the lower cavity 32 of the hydraulic piston 20.

The press 16 may further have a lower cover 27 having supports for the jaws 29 and a pyramid 28 may be coupled to the hydraulic piston 20. The jaws 29 are used to open and close sideways to reshape the casing pipe. The jaws 29 may contain rollers 30. The rollers 30 may be used to transmit the thrust force to the jaws 29.

Referring now to FIGS. 1-5, in operation, the press 1 is lowered into the interior of the well 101 by coupling as many segments 2A of double piping 2 that may be needed to reach the depth where the damage to the casing pipe 10 is located. The last of the segments 2A of the double piping 2 is attached to the directional valve 3 which is coupled to the power unit 4 and to the water tank 5 via a set of hoses and connections 6.

Once the system 100 is set-up in accordance with FIG. 1 as described above, the process of its hydraulic functioning to open the jaws 29 and generate a horizontal mechanical force necessary to reshape the casing pipe 10 is performed.

FIG. 5 shows the hydraulic functioning of the system 100 in order to open the jaws 29. The power unit 4 is supplied by the water tank 5. The power unit 4 pressurizes the water and sends the pressurized water to the directional valve 3. The directional valve 3 sends the pressurized water to the plurality of segments 2A of double piping 2.

When the directional valve 3 is triggered, the pressurized water is directed to the external pipe 7, towards the press 1 located where the casing pipe is damaged, finally arriving at the main feeder 11. Once in the main feeder 11, the pressurized water moves from the double piping 2 to the distributor 13, from the distributor 13 to the check valve 14, continues towards the pushing pipe 23, and to the upper cavity 31 of the hydraulic piston 20.

The pressure of the upper cavity 31 of the hydraulic piston 20 causes the hydraulic piston 20 to move down with the pyramid 28 which is coupled to the lower end of the piston rod 22. This causes the pyramid 28 to lean against the rollers 30, and the resulting angle leads for the lateral movement of the jaws 29. Through the rollers 30, the vertical force of the hydraulic piston 20 is mechanically broken down in two: a vertical force and a horizontal push which is the one that allows the casing pipe 10 to reshape within the damaged area.

The hydraulic circuit is completed when the pressurized water inside of the lower cavity 32 of the hydraulic piston 20 goes through the orifice 26 across the piston head 21 towards the return pipe 24, to the check valve 14, the distributor 13, and from the distributor 13 to the internal pipe 8 of the double piping 2. Next, the water moves from the internal pipe 8 to the directional valve 3 and finally returns to the water tank 5.

FIG. 6 shows the hydraulic functioning of the system 100 in order to close the jaws 29. When the jaws 29 close, the horizontal push is suspended, allowing the maneuvering of the press 1 together with the double piping 2.

Once the directional valve 3 is triggered, the pressurized water is conducted to the internal pipe 8 towards the press 1, located where the casing pipe is damaged. The pressurized water goes through the distributor 13 and the check valve 14, and arrives to the upper cavity of the internal cylinder 32-A, which communicates with the lower cavity 32 of the hydraulic piston 20 through the return pipe 24 and the orifice 26 across the piston head 21.

The pressure of the lower cavity 32 of the hydraulic piston 20 causes the hydraulic piston 20 to move up with the pyramid 28 which is coupled to the lower end of the piston rod 22. This stops the push of the pyramid 28 against the rollers 30, and the jaws 29 close by the gravity's force.

The hydraulic circuit is completed when the pressurized water inside of the upper cavity 31 of the hydraulic piston 20 goes to the pushing pipe 23 towards the check valve 14, the distributor 13, and from the distributor 13 to the external pipe 7 of the double piping 2. Next, the water moves from the external pipe 7 to the directional valve 3 and finally returns to the water tank 5.

These hydraulic cycles are repeated many times opening and closing the jaws 29, reshaping the casing pipe 10 of the well 101 in the damaged area.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A system for well casing pipe repair comprising:
a hydraulic circular press (1);
double piping (2) coupled to the hydraulic circular press (1);
a directional valve (3) coupled to the double piping (2);
a power unit (4) coupled to the directional valve (3); and
a fluid reservoir (5) coupled to the power unit (4).

2. A system for well casing pipe repair in accordance with claim 1 wherein the double piping (2) comprises:
a plurality of double piping segments (2A), wherein each of the double piping segments (2A) comprises:
an outer pipe (7); and
an inner pipe (8);
wherein the outer pipe (7) and the inner pipe (8) of each segment (2A) are in a concentric array.

3. A system for well casing pipe repair in accordance with claim 3 wherein pressurized fluid flows through one of the outer pipe (7) or inner pipe (8) to one of open or close the hydraulic circular press (1).

4. A system for well casing pipe repair in accordance with claim 1 wherein the hydraulic circular press comprises:
a main feeder (11) coupled to the double piping (2); and
a main body of the press (16).

5. A system for well casing pipe repair in accordance with claim 4 wherein the main feeder (11) comprises:
a bottom segment of double piping (2A′);
a distributor (13) coupled to the bottom segment of double piping (2A′);
a check valve (14) coupled to the distributor; and
a universal joint (15) coupled to the check valve (14) and to the main body of the press (16).

6. A system for well casing pipe repair in accordance with claim 4 wherein the main body of the press (16) comprises:
an upper cover (17) to couple the main body of the press (16) to the with the main feeder (11).
an external cylinder (18) positioned below the upper cover (17);
an interior cylinder (19);
a hydraulic piston (20) within the interior cylinder;
a pushing pipe (23) that goes through the upper cover (17) and the interior cylinder (19) to join a flow originating from an exterior pipe (7) to an upper cavity (31) of the hydraulic piston (20);
a return pipe (24) coupled to the upper end of the hydraulic piston (20) to join a flow originating from the interior pipe (8) with a lower cavity (32) of the hydraulic piston (20);
a pyramid (28) coupled to the piston;
jaws (29) that open and close sideways to reshape the casing pipe; and
a lower cover (27) to with support the jaws (29).

7. A system for well casing pipe repair in accordance with claim 6 wherein the main body of the press (16) further comprises a packing gland (25) coupled to the upper end of the hydraulic piston (20), the packing gland (25) allows the flow of pressurized fluid through an orifice (26) to the lower cavity (32) of the hydraulic piston (20).

8. A system for well casing pipe repair in accordance with claim 6 wherein the main body of the press (16) further comprises rollers (30) to transmit a thrust force to the jaws (29).

9. A system for well casing pipe repair in accordance with claim 6 wherein the hydraulic piston (20) comprises:
a piston head (21); and
a piston rod (22) coupled to the piston head (21).

10. A system for well casing pipe repair in accordance with claim 1 wherein the fluid reservoir (5) stores water, the water being the pressurized fluid.

11. A system for well casing pipe repair comprising:
a hydraulic circular press (1);
a plurality of double piping segments (2A), wherein each of the double piping segments (2A) comprises:
an outer pipe (7); and
an inner pipe (8);
wherein the outer pipe (7) and the inner pipe (8) of each segment (2A) are in a concentric array;
a directional valve (3) coupled to a first of the plurality of double piping segments (2A);
a power unit (4) coupled to the directional valve; and
a fluid reservoir (5) coupled to the power unit (4);
wherein the hydraulic circular press (1) comprises:
a main feeder (11) coupled to the double piping (2); and
a main body of the press (16).

12. A system for well casing pipe repair in accordance with claim 11 wherein the main feeder (11) comprises:
a bottom segment of double piping (2A′);
a distributor (13) coupled to the bottom segment of double piping (2A′);
a check valve (14) coupled to the distributor; and
a universal joint (15) coupled to the check valve (14) and to the main body of the press (16).

13. A system for well casing pipe repair in accordance with claim 12 wherein the main body of the press (16) comprises:
an upper cover (17) to couple the main body of the press (16) to the with the main feeder (11).
an external cylinder (18) positioned below the upper cover (17);
an interior cylinder (19) positioned in the top of the exterior cylinder (18);
a hydraulic piston (20) within the exterior cylinder;
a pushing pipe (23) that goes through the upper cover (17) and the interior cylinder (19) to join a flow originating from an exterior pipe (7) to an upper cavity (31) of the hydraulic piston (20);
a return pipe (24) coupled to the upper end of the hydraulic piston (20) to join a flow originating from the interior pipe (8) with a lower cavity (32) of the hydraulic piston (20);
a pyramid (28) coupled to the piston;
jaws (29) that open and close sideways to reshape the casing pipe; and
a lower cover (27) to with support the jaws (29).

14. A system for well casing pipe repair in accordance with claim 13 wherein the main body of the press (16) further comprises a packing gland (25) coupled to the upper end of the hydraulic piston (20), the packing gland (25) allows the flow of pressurized fluid through an orifice (26) to the lower cavity (32) of the hydraulic piston (20).

15. A system for well casing pipe repair in accordance with claim 13 wherein the main body of the press (16) further comprises rollers (30) to transmit a thrust force to the jaws (29).

16. A system for well casing pipe repair in accordance with claim 13 wherein the hydraulic piston (20) comprises:
a piston head (21); and
a piston rod (22) coupled to the piston head (21).

17. A system for well casing pipe repair in accordance with claim 11 wherein the fluid reservoir (5) stores water, the water being the pressurized fluid.

18. A method for repairing casing pipe (10) in a well (101) comprising:
providing a system for well casing pipe repair comprising: a hydraulic circular press (1); double piping (2) coupled to the hydraulic circular press (1); a directional valve (3) coupled to the double piping (2); a power unit (4) coupled to the directional valve; and a fluid reservoir (5) coupled to the power unit (4).
lowering the hydraulic circular press (1) into the interior of the well (101) where the damaged casing pipe (10) is located;
sending pressurized water from the directional valve (3) to an external pipe (7) of the double piping (2) and to the hydraulic circular press (1) located where the casing pipe (10) is damaged.

19. The method of claim 18 wherein sending pressurized water from the directional valve (3) to an external pipe (7) of the double piping (2) and to the hydraulic circular press (1) located where the casing pipe (10) is damaged further comprises:
sending pressurized water to a main feeder (11) of the circular press (1), the pressurized water moving from the external pipe (7) to a distributor (13);
sending the pressurized water from the distributor (13) towards a pushing pipe (23), and to an upper cavity (31) of a hydraulic piston (20), causing the hydraulic piston (20) to move down with a pyramid (28) which is coupled to a lower end of the hydraulic piston (20) causing the pyramid (28) to lean against rollers (30), and moving jaws (29) outwardly.

20. The method of claim 19 further comprising sending the pressurized water inside of a lower cavity (32) of the hydraulic piston (20) through an orifice (26) across a piston head (21) towards a return pipe (24), to a check valve (14), the distributor (13), and to an internal pipe (8) of the double piping (2) and back to the water tank (5).

21. The method of claim 19 further comprising closing the jaws (29) allowing maneuvering of the hydraulic circular press (1) together with the double piping (2).

22. The method of claim 21 wherein closing the jaws (29) further comprises: sending the pressurized water to an internal pipe (8) of the double piping (2) towards the hydraulic circular press (1), the pressurized water goes to the lower cavity (32) of the hydraulic piston (20) causing the hydraulic piston (20) to move up the pyramid (28) and closing the jaws (29).
